(19) United States
(12) Patent Application Publication
(10) Pub. No.: US 2016/0344813 A1
(43) Pub. Date: Nov. 24, 2016

(54) Molecular Transcription Resonance Structure

(71) Applicant: Chui-Ping Hu, Taichung City (TW)

(72) Inventor: Chui-Ping Hu, Taichung City (TW)

(21) Appl. No.: 14/718,041

(22) Filed: May 20, 2015

(51) Int. Cl. H04L 29/08; H04B 13/00

(52) U.S. Cl. CPC H04L 67/12; H04L 67/04; H04B 13/005

(57) ABSTRACT

A molecular transcription resonance structure includes a host device and an operation device. The host device includes a processor, a molecular carrier data module, a molecular carrier input module, a molecular carrier selection module, a resonance device, and a transcription device. To use, molecular carriers of photographs and motion pictures associated with medical treatment and health caring are input via the molecular carrier input module to the molecular carrier data module. Molecules of a human body are transcribed through the transcription device to the molecular carriers to be subjected to resonance by the resonance device. After the resonance, the molecules are fed back to the human body to achieve an effect of body health caring. The user may use the molecular carrier selection module to make selection among the molecular carriers so as to achieve an effect of personalization and customization.

### TECHNICAL FIELD OF THE INVENTION

The present invention relates generally to a molecular transcription resonance structure, and more particularly to one that applies a molecular transcription resonance principle to allow a user to select a molecular carrier and to transcripts body molecules to the molecular carriers to be subjected to resonance and to allow the molecules, after the resonance, to be fed back to the body thereby achieving a function of body health caring.

### DESCRIPTION OF THE PRIOR ART

According to statistics, around 90% of the global health care resources is consumed by about 3% of people, while the remaining 70% of people, who need to first keep surviving and feeding their families, delays proper treatment of their diseases. This is the reason that the average life expectancy in the undeveloped regions is only 45-50 years old. It can be imaged that this range of age is that a person is in the most peak period in respect of physical strength, experience, and productivity. If the person is dead at this time, the family will be in trouble and the children will face poverty.

For regions where public heat care projects are adopted, the situation is not much better. The government and employers are almost overwhelmed by the enormous health care expenditure. Residents have to pay more money out of their own pockets year by year; however, the improvement of the medical environment is almost negligible.

It is quite questionable if any detailed statistics relating to this issue have been carried out before. Annual expenditure of national medical expenses, loss of business community, and personal expenses would show figures and a curve of stepwise rising year by year if such statistics had been done by institutions.

Therefore, if a molecular transcription resonance structure is available for dissociation, transfer, and resonance of molecules so as to achieve an effect health caring, the patients are allowed to carry out medical treatments and health caring at any time and any place so that the patients do not need to travel a long distance to see a doctor and there is no need to take a lot of drugs and medicines so as to save money. Countries may cut down the national health expenditures and governments may use these moneys so saved to take care of more patients requiring treatments with highly specialized medical technology so that all patients in need of help can have equal opportunity to receive the best medical treatment.

### SUMMARY OF THE INVENTION

An object of the preset invention is to provide a molecular transcription resonance structure that applies a molecular transcription resonance principle to first input molecular carriers including photographs and motion pictures of medical treatment and health caring and also allows molecules of a body to be transcribed to the molecular carriers for resonance and also allows the molecules that have been subject to the resonance to be fed back to the body to thereby achieving a function of health caring of the body.

Another object of the present invention is to provide a molecular transcription resonance structure that allows a user to select, at their desires, molecular carriers of photographs and motion pictures of medical treatment and health caring for use.

To achieve the above objects, the present invention comprises a host device and an operation device. The host device comprises: a processor; a molecular carrier data module, which is connected with the processor for storing molecular carriers; a molecular carrier input module, which is connected with the molecular carrier data module for inputting the molecular carriers into the molecular carrier data module; a molecular carrier selection module, which is connected with the processor and the molecular carrier data module to allow a user to make selection among the molecular carriers; a resonance device, which is connected with the processor; and a transcription device, which is connected with the processor, the transcription device being a sound recording device that picks up sounds and transcribes the sounds to the molecular carriers. The operation device is connected with the host device.

The molecular carrier input module can be used to input molecular carriers of medical treatment and health caring related photographs and motion pictures into the molecular carrier data module, so that there is no need to download the molecular carriers through the network. Molecules of a human body are transcribed through the transcription device to the molecular carriers to be subjected to resonance by the resonance device. After the resonance, the molecules are fed back to the human body to achieve an effect of body health caring. The user may use the molecular carrier selection module to make selection among the molecular carriers so as to achieve an effect of personalization and customization.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is a block diagram of the present invention.

FIG. 3 is a perspective view showing an example of a mobile phone as a combination of a host device and an operation device of the present invention.

FIG. 4 is a planar schematic view illustrating the use of electron oscillation and enhanced electronic oscillation.

FIG. 5 is a schematic view illustrating the use of electron oscillation and enhanced electronic oscillation.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

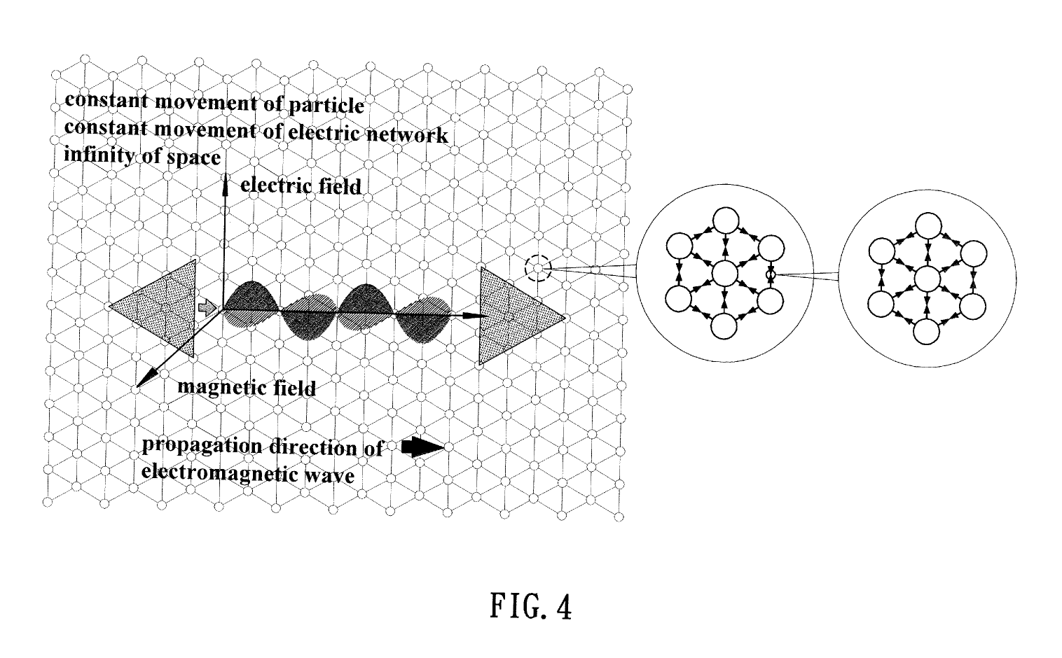

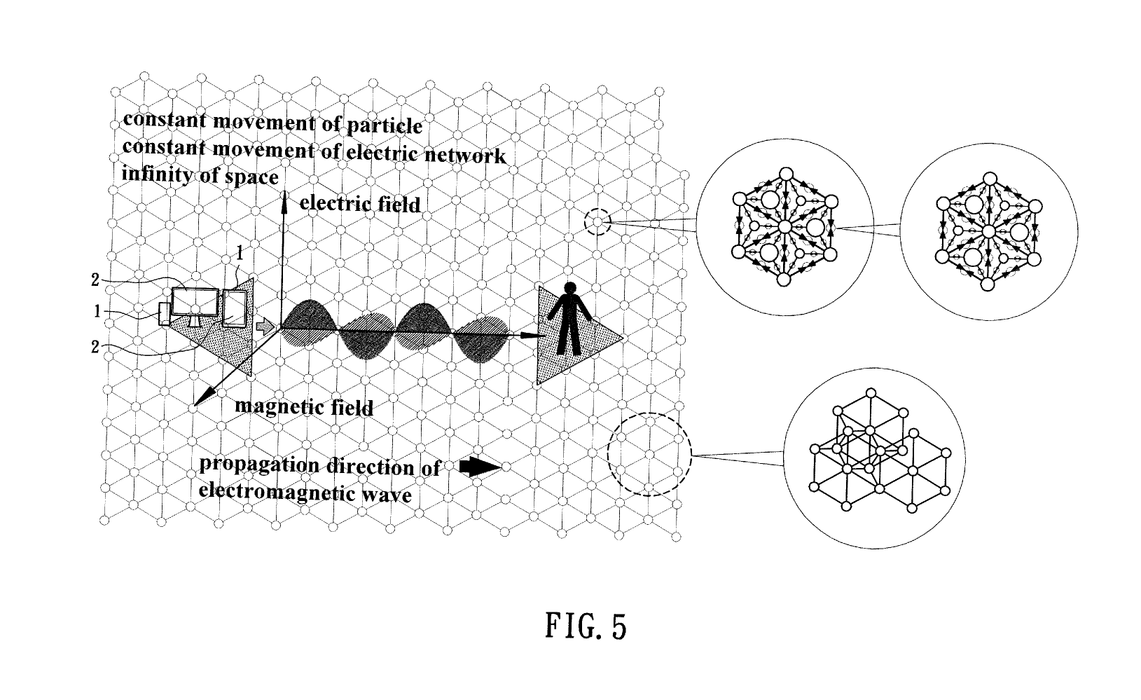

Referring to FIGS. 4 and 5, the present invention is an application of time-space electric network theory. The basic principle will be introduced first.

The characteristics of particles are eternal, constant moving, jumping, not continuous, requiring a sufficient quantity to act on a specific target.

Even if the speed of the particles is as fast as the speed of light, as long as they can be converted into a portable mode, they possesses the nature of mass and may generates a force of interaction force. A telecommunication network built up with the constant movement of charged particles in space may be used to construct a message transfer path.

What is the correlation between the photoelectric theory and photograph transcription?

Firstly, a human body is though of as a quantum person and light particles are tightly bonded by gravitational force to form a human body full of mass. The human body is extremely sensitive to light so that the natural light or flash light used in photographing comprises a fraction that is of a high frequency and will shoot down particles of the human body to pass through a variety of lenses and reaches a film for development of an image. This is equivalent to the particles travelling a distance and staying in a piece of photographic paper.

The photographic paper itself has its own matter waves and its own electric charge repulsion. The particles that reach the photographic paper also has its own matter wave and its own electric charge repulsion, they are due to gravitation and binding, but also because the charge repulsion, but are bonded by universal gravitation force and also keep their distance due to the electric charge repulsion. It is amazing that the particles that leave the mother body still hold a memory of the mother body, since the frequency of the combination of particles does not disappear. This is just like two puzzles, which, even through separated, can be puzzled together in view of the colors and the shapes and return to their original places.

People have already known flying a kite in the sky needs a line for control and also, an aircraft needs a pilot to fly. People can now accept the ideas of remote control robots, artificial satellites, mobile phones, and also space immigration. People will just say “why not?”

The space-time electric network theory provides a measure for completion of space medical researches and also provides a direction for the researches of “instantaneous movement”.

For example, if you are in Russia and your sister in the United States gets sick, as long as her voice has been stored in a phone, you will be able to treat her in the Russia.

Moreover, you do not need to have a line connection with your phone, computers, and your sister and your sister does not need to have the software. You can freely move to anywhere.

How is this exactly done will be explained as follows:

The entirety of our space-time is composed of oscillating particles. The eternal or constant movement of the particles constitutes an electrical network. All things are composed of the constantly moving particles, including “strings”, which are composed of string particles. When a substance moves, the particles of the substance impact the electric network and an infinite number of uncountable electromagnetic waves are generated. This is the space-time that we are living in.

If the particles of the substance are separated, they are still entangled together. Further, with an external factor strengthening the oscillation of A1, A2 will follow the oscillation. Even through A1 is in Russia and A2 is in the United States, the particles will be entangled and oscillating, even A1 being in the earth and A2 on Mars, the situation will be the same no matter how far away they are.

An actual example of the particle entanglement theory is as follows:

For example, in a multiple car accident, the accelerated travel speeds of electromagnetic waves cause the formation of a greater electric field, which provides more electrical power. Regardless of the shape and the direction of movement, the space-time field is complete, continuous, and not splittable. The time-space particles exist eternally. Through the entanglement of the space-time particles, the particles of “now” is the entanglement of the particles of “past” and those of “future” and the particles of “future” are entanglements of the particles of “now” and those of “past”. Sounds and photographs can be used permanently.

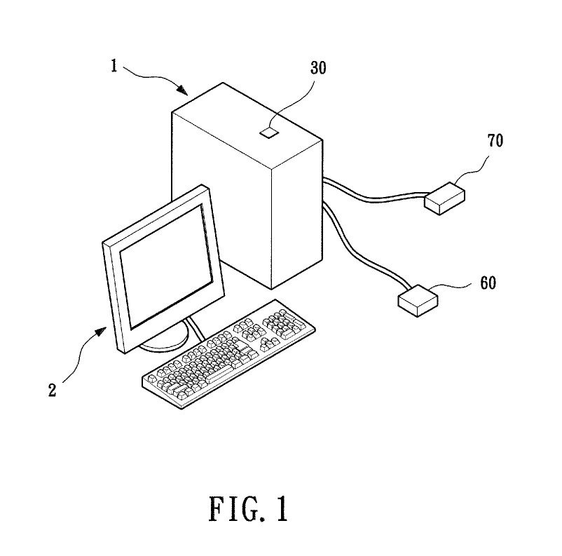

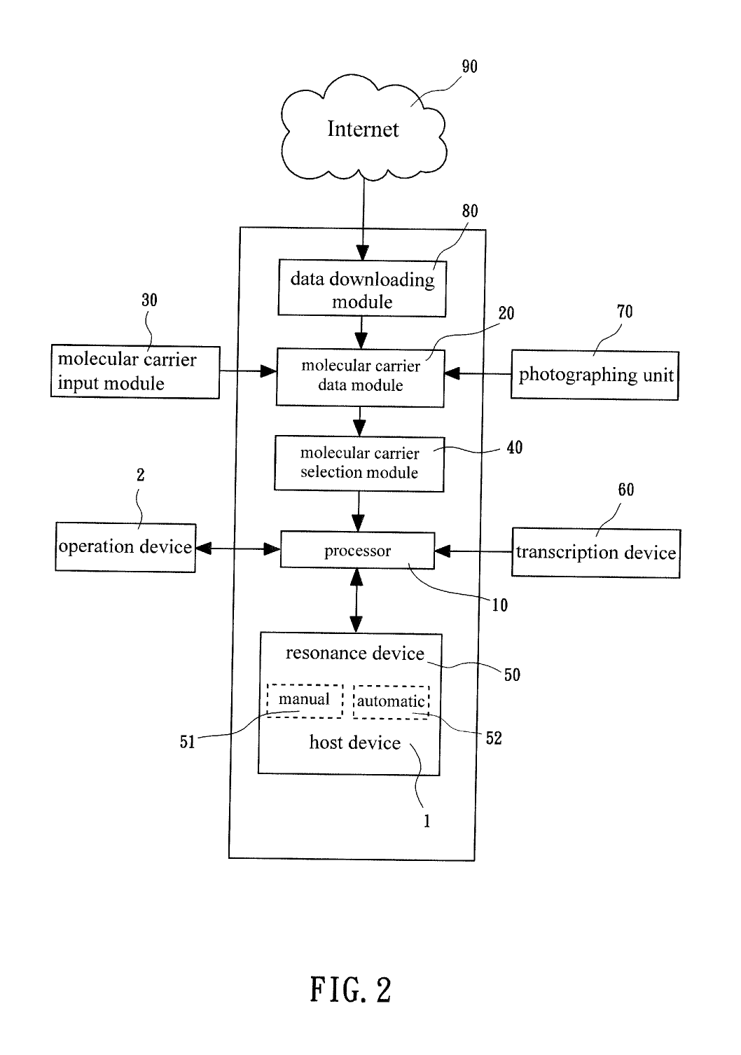

Referring to FIGS. 1 and 2, the present invention provides a molecular transcription resonance structure, which adopts the molecular transcription resonance principle and comprises a host device 1 and an operation device 2, wherein the host device comprises a processor 10, a molecular carrier data module 20, a molecular carrier input module 30, a molecular carrier selection module 40, a resonance device 50, and a transcription device 60. Details will be provided as follows:

The processor 10 is operable to process and compute data.

The molecular carrier data module 20 is connected with the processor 10 to store molecular carriers.

The molecular carriers can be medical treatment and health caring related images, texts, photographs, and motion pictures, including meridian-collateral diagrams, human anatomy diagrams, reflexology charts, photographs of single compound formulas, photographs of western medicines, biological high-quality photographs, or photographs, X-ray image, and computed tomography images of patients.

The molecular carrier input module 30 can be for example an optic disc driver and a USB port and is connected with the molecular carrier data module 20 for input of molecular carriers into the molecular carrier data module 20.

The molecular carrier data module 20 may also be connected with a photographing unit 70, such as camera. The photographing unit 70 is operable to photograph and generate a photograph molecular carrier for input to the molecular carrier data module 20.

The molecular carrier data module 20 may also be connected with a data downloading module 80. The data downloading module 80 is connectable with an internetwork 90 for input molecular carriers downloaded through the internetwork 90 into the molecular carrier data module 20.

The molecular carrier selection module 40 is connected with the processor 10 and the molecular carrier data module 20 to allow a user to make selection among molecular carriers.

The resonance device 50 is connected with the processor 10 for generating a resonance effect on the molecular carrier and body molecules transcribed to the molecular carriers.

The transcription device 60 is connected with the processor 10. The transcription device 60 is a sound recording device that picks up sounds and transcribes audio waves to the molecular carrier.

The operation device 2 is connected with the host device 1 to allow the user to operate and control the host device 1.

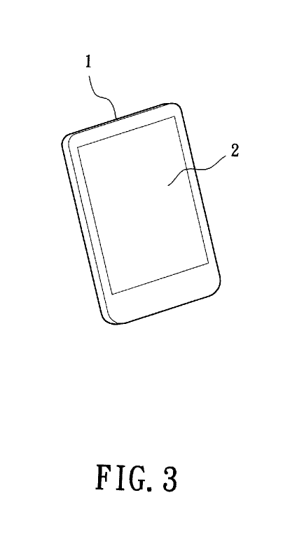

The host device 1 and the operation device 2 may be combined to be in the form of for example a mobile phone, a computer, and a tablet computer. As shown in FIG. 1, the host device 1 and the operation device 2 are combined as a computer and FIG. 3 shows the host device 1 and the operation device 2 are combined as a mobile phone. As such, through operation of a mobile phone, medical treatment and health caring can be realized.

The components of the present invention have been described above. The principle of operation and characteristics of performance will be explained as follows:

A user uses the molecular carrier input module 30 to input molecular carriers, which are particularly molecular carriers of photographs and motion pictures related to medical treatment and health caring, such as photographs of single compound formulas, photographs of western medicines, biological high-quality photographs, or photographs, X-ray image, and computed tomography images of patients, into the molecular carrier data module 20, so that there is no need to download the molecular carriers from networks, and molecules of a human body are transcribed by means of the transcription device 60 to the molecular carriers and are subjected to resonance by means of the resonance device 50 so as to achieve dissociation, transfer, and resonance of the molecules. The molecules, after the resonance, are fed back to the human body to achieve an effect of body health caring.

The user may use the operation device 2, in combination with the molecular carrier selection module 40, to select desired ones of the molecular carriers in order to achieve an effect of personalization and customization.

The resonance device 50 comprises a manual resonance device 51 and an automatic resonance device 52. The user uses the manual resonance device 51 to proceed with manual clicking resonance by following the circulation direction of the molecular carrier, such as a meridian-collateral diagram, and may alternatively or additionally use the automatic resonance device 52 to proceed with automatic clicking resonance.

Besides using the transcription device 60 to transcribe the body molecules, through sound or audio waves, to the molecular carrier, it is also possible to adopt other measures, such as chemical-electric signals, touches, air blowing, electrocardiography, to transcribe the body molecules to the molecular carrier.

Referring to FIGS. 4 and 5, how can the effective particles of the molecular carriers be transmitted back to the human body?

For transcription of superior quality of medicines or animals to the human body or transcription of molecules of the human body to the anatomy for reforming, what is the tool through which the transcription is made? In fact, this is done by constantly playing the sounds or voices of the patient through a computer. It should be noted that the voices of the patient are loaded into the computer in advance and are then by the computer. Taking the way of the operation of electrons in a flash memory as an example for explanation, electrons that enter the small space cannot get out even if power is set off and must wait for the next instruction. Thus, data can be stored. Our voices are also stored in this way. When voltage changes, electrons are allowed to move out of a floating gate. The small space holds therein no electrons so that our voices are played out. Of course, there are some complex conversion processes in the middle of the operation. However, different voices of a patient can be presented in an actual way by changing the voltage of an electronic circuit. In everyday life, even if we do not see each other, we can distinguish different people according to different voices, including animals, materials, and even the person giving off the sound body being now is healthy or sick, happy or angry, sleepy, tired, or spirited. Although there will be a slight change in frequency, we can tell this voice belongs to Miss A and that voice belongs to Mr. B according to the unique sound frequency of each person. Frequency is also an activity of electrons. Therefore, we can say: whosever sound is played by a computer, that sound has a sufficient amount of electrons.

The vibration wave of sound stands for two meanings in the present invention:

One is that it is broadcast in the field of the computer, so that it will affect the image that is being clicked by the computer. When click is made on an anatomy diagram, we can set repeated clicking the region of click so that the electron activity of the sound gets resonant with the electron activity of the block so set, noting the meaning of the saying is that “they are co-existing in the field of the same computer”.

The second is that the voice of a patient is the voice particles of the patient particle. All masses present a force of mutual attraction. The greater the masses, the greater the attraction force. The smaller the masses, the smaller the attraction force. Thus, the voice particles will spread with electromagnetic waves generated by vibration waves and get resonant with an object having the same resonance frequency. This is the same as the principle of objects of the same frequency resonating with each other as stated in physics.

However, please note one more thing. Transmission of message from a computer back to a human body is not the same. The following triangular relationship is used for illustration. A computer plays a sound as A, anatomy diagram that is being clicked is B, a patient is designated C. A is the natural frequency of C and constantly playing constantly forces resonance to occur. Particles of C particles will be attracted into the computer. The computer is set to repeatedly click B. Under this condition, A, B, and C will resonate with each other. Since this is regular resonance, the random movements of electrons will be rearranged, so that the message that is transmitted back to the patient is on that has been managed.

For condensed matter physics, from an application point of view of the present invention, the meaning that a semiconductor stands for is not just a description of the use of the physical property of silicon and germanium that exist between the metal and the insulator, nor does the use that all sorts of devices that they can make by mixing with other substances and combining various semiconductors, such as “diodes” and “transistors”, followed by combining these devices together to make the hearts of computers-integrated circuits (ICs). Rather, what is emphasized here is the mechanism of using these carriers to adjust and control the electron activity by changing voltages. The clicking operation that we see on a computer is actually the activity of uncountable electrons in integrated circuits. When there are regular electron activities, there are electric fields generated. The electric fields are locked in the computer. Writing sound into the computer or cyclically playing the sound are all occurring the electric field. For any sound given off from an object, regardless if the time period is one second or one minute, the eternal existence of particles makes the written sound to be used forever. Of course, if the sound so written is from a person who is being sick, then even through the particles have left the body of the patient, they can be re-attracted back into the object through constantly playing, provided there is a sufficient amount. Thus, it is suggested the voice of a healthy body is recorded when the person is healthy.

Next, explanation will be given that although the computer may transmit the effectiveness of the reformation back to the human body, how does it do without cable connection?

Since Franklin discovered electricity, we are educated that in order to make the machine work, the machine must be connected through a cable to electricity. With the progress of science and technology, it is known that communications can be made between cells phones without cable connection; however, no signal will be received without base stations. Why the present invention can fix the human body mechanism without the use of connection cable/wire and base stations?

In the field of physics, if the progress of an electromagnetic wave is illustrated in an exploded form, it can be found that that the vector magnitudes and directions of electric and magnetic fields change constantly. In other words, electrons that is located in the traveling path of the electromagnetic waves will be subjected to the force of the electric field vector and thus oscillates. When radio waves are transmitted through a radio station, electrons inside an antenna oscillate and the flow of the electrons that is current. This indicates a current is generated inside the antenna and the message carried by the radio waves can be obtained from the current signal. Mobile phones and TV antenna are designed by using the principle.

This principle is also applicable to the human body. Man is a conductor and is thus an antenna, but the structure and constituent elements are different from those of the antenna. However, the electron activity exists inside the human body, just like that of the antenna. Ultrasound, X-ray imaging, tomography, and magnetic resonance are used to treat diseases by reading the electron activity inside the human body. The flow of electrons is an electric current. The human body is just like an antenna when receiving messages and the body itself is also a radio station. The sound emitted by the human body is just one mode of emission of electromagnetic waves.

In the modem technology, in the areas where base stations have been set up, signal receiving is better for mobile phones and no signal can be received in areas where no base station is built. The reason that molecular target software be executed without access to the Internet is that electromagnetic waves can be transmitted without a base station.

How far the electromagnetic waves can be transmitted? If the activity of electron and charged particles are regarded as a wave, that would certainly a limit of transmission distance. However, if their activities is viewed in respect of the characteristics thereof, then they are forever, jumping, not continuous, and requiring a sufficient quantity to act on a specific object and they can reach the same distance from Earth as we observe the light of stars; the can reach as far as the light may reach.

When the current changes, the magnetic field will change around, and when the magnetic field changes, it will generate an electric field around; and when the electric field changes, a magnetic field is generated around again, and due to the change of the magnetic field, and an electric field will then be generated around. Such a process of change will repeatedly and alternatively cycled and spread outward in the form of waves. Because of the success development of various instruments, infrared, ultraviolet, X-rays, and r-rays can now be detected. However, there is still electromagnetic waves that cannot be accurately detected by equipment. When equipment is used to detect the activity of electrons and charged particles, there is no way to predict where and how many electrons will appear and this is the known uncertainty theory. However, it is known that electrons and charged particles are always existing in the space and repeatedly collide with each other in a very small space. This movement and the impact itself will generate electricity. The nature of an object existing in a physical space is composed of the smallest particles, all these particles oscillating, this being the so-called matter waves and being discussed previously. Each material has its inherent natural frequency so do human beings and animals. More accurately speaking, every person and every object has a frequency that is different from the others and the difference is the greatest for living things. Such an inherent frequency is generated by the oscillation of the particles that constitute the material. When he material oscillates, electronics and charged particles in the spaced are affected by the oscillation and resonance occurs. Then, the following relationship occurs:

(1) Electrons and charged particles in the space oscillate by themselves and self-oscillation also affects the oscillation of particles of an object in the space.

(2) An object in the space oscillates by itself and the self-oscillation also affects the oscillations of electrons and charged particles in the space.

Such active and passive form of interaction in the space form an electrical network and particles can reach a distance of infinity.

How to control the direction of the particles of the object and which should be the destination to reach? First, the natural frequency of the object must be strengthened. According to the principle of wave propagation oscillation, if it is attempted to have A moved from B domain to C domain, then A and C domain must be of the same frequency and it only needs to strengthen the matter wave of A in the B domain in order to the particle swarm of A to resonate with particles in the C domain. Strengthen matter waves is to strengthen the activities of electrons and charged particles. As mentioned previously, when the current changes, the magnetic field will change around and when the magnetic field changes, it will generate an electric field around, and when the electric field changes, a magnetic field is generated around again. Due to the change of the magnetic field, an electric field is generated around again. Such a change is repeatedly and alternatively cycled and is spread out in the form of waves and advances through jumping with the characteristics of the particles. As long as the action of forced oscillation does not stop, the electromagnetic waves will continue propagate forward. The object wave that has the same frequency as that of the electromagnetic wave, upon receiving a sufficient amount of particle fluctuations, will resonate accordingly.

Thus, as long as the voice of a patient is kept playing from a computer, the fluctuation of the sound particles will continue to oscillate. The electrons of the patient would have self oscillation so that they can easily find each other through attraction. The mass of the patient is large and thus the attraction force is great so as to attract the particles carried by the sound particles. The particles attracted to the body of the patient impact the inherent particles of the body of the patient to generate new bond, this helping reforming the human body mechanism.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A molecular transcription resonance structure, comprising:
a host device, which comprises:
a processor;
a molecular carrier data module, which is connected with the processor for storing molecular carriers;
a molecular carrier input module, which is connected with the molecular carrier data module for inputting the molecular carriers into the molecular carrier data module;
a molecular carrier selection module, which is connected with the processor and the molecular carrier data module to allow a user to make selection among the molecular carriers;
a resonance device, which is connected with the processor; and
a transcription device, which is connected with the processor, the transcription device being a sound recording device that picks up sounds and transcribes the sounds to the molecular carriers; and
an operation device, which is connected with the host device.

2. The molecular transcription resonance structure according to claim 1, wherein the molecular carrier data module is connected with a photographing unit, which makes photographing to generate photograph molecular carriers to be input to the molecular carrier data module.

3. The molecular transcription resonance structure according to claim 1, wherein the molecular carrier data module is connected with a data downloading module, the data downloading module being connectable with internetwork for inputting molecular carriers downloaded through the internetwork into the molecular carrier data module.

4. The molecular transcription resonance structure according to claim 1, wherein the resonance device comprises a manual resonance device and an automatic resonance device.
